(19) United States
(12) Patent Application Publication
(10) Pub. No.: US 2026/0189748 A1
(43) Pub. Date: Jul. 2, 2026

(54) METHOD AND DEVICE FOR VIDEO CACHING, DEVICE AND STORAGE MEDIUM

(71) Applicant: Beijing Bytedance Network Technology Co., Ltd., Beijing (CN)

(72) Inventors: Aoyang ZHANG, Beijing (CN); Wei HE, Beijing (CN); Qing HUANG, Beijing (CN); Tianze YU, Beijing (CN); Zhendong ZHONG, Beijing (CN); Qian MA, Beijing (CN)

(21) Appl. No.: 18/861,866

(22) PCT Filed: May 10, 2023
(86) PCT No.: PCT/CN2023/093158

§ 371 Date: Oct. 30, 2024

(30) Foreign Application Priority Data
May 23, 2022 (CN) 202210564572.7

(51) Int. Cl. H04N 21/433; H04N 21/239; H04N 21/44; H04N 21/442

(52) U.S. Cl. CPC H04N 21/4331; H04N 21/2393; H04N 21/44004; H04N 21/44209

(57) ABSTRACT

The embodiment of the invention provides a method and apparatus of video caching, device and a storage medium. A method includes obtaining an actual cached amount of video data and a set cache threshold in a video playback process; determining a target download amount based on the actual cached amount and the set cache threshold; requesting, from the server, video data of the target download amount for caching.

This application claims the benefit of Chinese Patent Application No. 202210564572.7, filed May. 23, 2022, which is hereby incorporated by reference in its entirety.

### FIELD

The embodiment of the invention relates to the technical field of communication, in particular to a method and apparatus for video caching, device and a storage medium.

### BACKGROUND

During the playback process of the online video, the client may request video data from the server continuously and put the downloaded data in the video buffer. The buffer is used to solve the stutter caused by bandwidth jitter in the playback process, and the relative playing progress can download part of data in advance.

In the related art, as long as the video is still playing and the download of the video has not been completed, the download process will continue, which may lead a download of many data to the client. If the user will not watch all the downloaded data, a significant difference is formed between the playback completion rate and the download completion rate, which may cause data waste, and meanwhile an increase of the data transmission cost.

### SUMMARY

The embodiment of the invention provides a method and apparatus for video caching, device and a storage medium, to achieve a control of the video data caching, which may reduce the data waste rate and save the transmission cost.

Embodiments of the present disclosure provides a method of a method of video caching comprising:
Obtaining an actual cached amount of video data and a set cache threshold in a video playback process;
Determining a target download amount based on the actual cached amount and the set cache threshold;
Requesting, from the server, video data of the target download amount for caching.

Embodiments of the present disclosure further provides an apparatus of video caching comprising:
An obtaining module, configured to obtain an actual cached amount of data video and a set cache threshold in a video playback process;
A target download amount determination module, configured to determine a target download amount based on the actual cached amount and the set cache threshold;
A caching module, configured to request, from the server, the video data of the target download amount for caching.

Embodiments of the present disclosure further provides an electronic device, including:
One or more processors;
A storage device configured to store one or more programs;
The one or more programs, when executed by the one or more processors, implement the method of video caching according to the embodiments of the present disclosure.

Embodiments of the present disclosure further provides a storage medium including computer executable instructions that, when executed by a computer processor, for performing the method of video caching according to the embodiments of the present disclosure.

### BRIEF DESCRIPTION OF DRAWINGS

Throughout the drawings, the same or similar reference numbers refer to the same or similar elements. It should be understood that the drawings are schematic, and elements and elements are not necessarily drawn to scale.

FIG. 1 is a schematic flowchart of a method of video caching according to embodiments of the present disclosure;

FIG. 2 is a schematic structural diagram of an apparatus of video caching according to embodiments of the present disclosure;

FIG. 3 is a schematic structural diagram of an electronic device according to embodiments of the present disclosure.

### DETAILED DESCRIPTION

Embodiments of the present disclosure will be described in more detail below with reference to the accompanying drawings. It is to be understood that the drawings and embodiments of the present disclosure are only for example purposes and are not intended to limit the scope of protection of the present disclosure.

It should be understood that the steps recited in the method embodiments of the present disclosure may be performed in different orders, and/or in parallel. The scope of the present disclosure is not limited in this respect.

In the description of embodiments of the present disclosure, the term “comprise(s)”and similar terms shall be understood as open inclusion, that is, “including but not limited to”. The term “based on” is to be understood as “based at least in part on”. The term “one embodiment” is to be understood as “at least one embodiment”. The term “a further embodiment” is to be understood as “at least further embodiment”. Other explicit and implicit definitions may also be comprised below.

It should be noted that concept concepts such as “first” and “second” mentioned in this disclosure are merely used to distinguish different apparatuses, modules, or units.

It should be noted that the modification of “a” and “a plurality” mentioned in this disclosure is illustrative, and those skilled in the art should understand that “one or more” should be understood unless the context clearly indicates otherwise.

The names of messages or information interaction between multiple devices in embodiments of the present disclosure are for illustrative purposes only.

It is to be understood that, before the technical solutions disclosed in the embodiments of the present disclosure are used, the types of personal information related to the present disclosure, the usage scope, the usage scenario and the like should be notified to the user in an appropriate manner according to the relevant laws and regulations and obtain the authorization of the user.

For example, in response to receiving an active request from a user, prompt information is sent to the user to explicitly prompt the user that the requested operation will need to acquire and use the personal personal information of the user. Therefore, the user can autonomously select whether to provide personal information to software or hardware executing the operation of the technical solution of the present disclosure according to the prompt information.

As an optional implementation, in response to receiving the active request of the user, the manner of sending the prompt information to the user may be, for example, a pop-up window, and the prompt prompt information may be presented in a text manner in the pop-up window. In addition, the pop-up window may further carry a selection control for the user to select “agree” or “not agree” to provide personal information to the electronic device.

It may be understood that the foregoing notification and obtaining user authorization processes are merely illustrative, and other manners of meeting related laws and regulations may also be applied to implementations of the present disclosure.

It may be understood that the data involved in the technical solution (including the data itself, the acquisition or use of the data) should follow the requirements of the corresponding laws and regulations and related regulations.

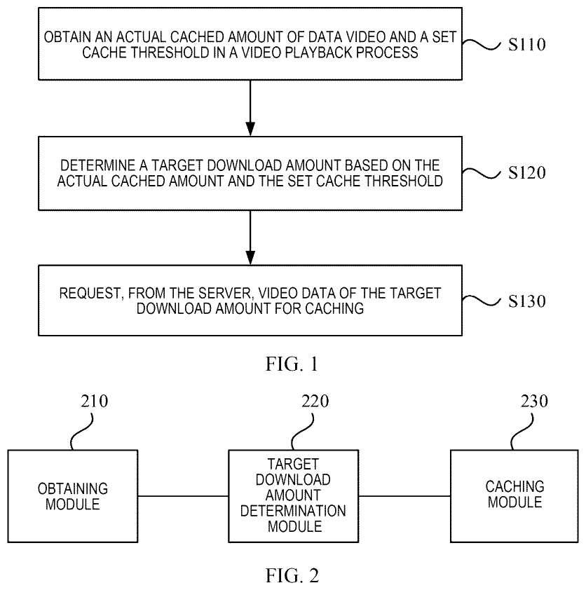

FIG. 1 is a flow diagram of a method of video caching provided by the embodiments of the present disclosure. The embodiments of the present disclosure is applicable to the case of controlling the caching of video data. The method can be implemented by a video caching device, which can be implemented in the form of software and/or hardware. Optionally, it can be implemented by an electronic device, which can be a mobile terminal, a personal computer (PC) terminal, a server, etc.

Video playback may need a coordination of two modules, namely a first part is a player and a second part is a data download module. The data download module is responsible for downloading video data from the server, the player reads data from the data download module, and displays the video to the user after decoding and rendering the data. The data download module stores the data downloaded from the server into the cache of the data download module, the player continuously reads the data from the data download module, and then stores the read data in the player buffer area. The data cached by the player is the data that the player has read from the data download module but has not yet been played. The data cached by the data download module is the data that the data download module has downloaded from the server, but the player has not yet read.

The request process of the playback in the related art is that: the user starts watching the video→player to initiate the data download request to the data download module→the data download module continuously requests the data from the server. The download process may continue as long as the user is still watching the video and the video file does not complete the download. The above-mentioned download mode causes many data to be downloaded to the client, but if the cached data is not watched by the user, a significant difference is formed between the playback completion rate and the download completion rate, so that the downloaded but unwatched part of data is wasted. To reduce the waste rate and save the transmission cost, a control of the download amount of data can be achieved in the embodiments.

As shown in FIG. 1, the method comprises:
S110: Obtain an actual cached amount of video data and a set cache threshold in a video playback process.

The actual cached amount may be the amount of video data that has been cached currently but not been played by the client, and the actual cached amount is obtained by adding the cached amount in the player to the cached amount in the data download module. The set cache threshold may be set by the user, which may be a hyperparameter.

In some embodiments, the actual cached amount and the set cache threshold may be represented by an amount of data (for example, Kb, Mb or Gb), or may be represented by a video duration. It is assumed that the actual cached amount is the actual cached video duration, and the set cache threshold is the set cache duration threshold.

S120: Determine a target download amount based on the actual cached amount and the set cache threshold.

The target download amount may be understood as the amount of video data requested to the server.

Optionally, the determining the target download amount based on the actual cached amount and the set cache threshold may be: in a case where the actual cached amount is greater than or equal to the set cache threshold, the target download amount is determined as a set value; and in a case where the actual cached amount is less than the set cache threshold, the target download amount is obtained by processing the actual cached amount and the set cache threshold by using a set optimization algorithm.

The set value may be 0, that is, when the actual cached amount is greater than or equal to the set cache threshold, pause requesting video data from the server.

The set optimization algorithm may be Lyapunov optimization algorithm. For example, if the actual cached amount is less than the set cache threshold, the process of using the set optimization algorithm to process the actual cached amount and the set cache threshold can be as follows: Based on the set optimization algorithm, an optimization function based on the actual cached amount and the set cache threshold is constructed, and the constraint conditions of the independent variables in the optimization function are set. Based on the constraint conditions, the optimization function is optimized and iterated until the optimal target corresponding to the independent variable is determined, and the independent variable value corresponding to the optimal target is the target download amount.

Optionally, the process of obtaining the target download amount by processing the actual cached amount and the set cache threshold by using the set optimization algorithm may be: obtaining a plurality of candidate download amounts; obtaining a processing result corresponding to each candidate download amount by processing the actual cached amount, the set cache threshold and each candidate download amount by using the set optimization algorithm, determining a candidate download amount corresponding to a maximum processing result, among processing results corresponding to all candidate download amounts, as a target download amount.

The candidate download amount may be represented by an amount of data (such as Kb, Mb or Gb, etc.) or a video duration. If the candidate download amount is represented by the video duration, the candidate download amount is the candidate download video duration. In some embodiments, the plurality of candidate downloads may be randomly selected from the above constraint conditions, for example: assuming that the constraint is any value between 1-10 seconds, a plurality of values may be randomly selected from 1-10 as candidate downloads. Alternatively, the plurality of candidate download amounts may be preset by the user, i.e., the download amounts of different level available for selection, for example, the candidate download amount set by the user may be: [2, 4, 6, 8], and if 6 is selected, then video data of 6 seconds is to be downloaded.

In some embodiments, the process of processing the actual cached amount, the set cache threshold and each candidate download amount by using the set optimization algorithm may be: constructing, based on a set optimization algorithm, an optimization function constructed by an actual cached amount, a set cache threshold, and a candidate download amount, obtaining a target value corresponding to each candidate download amount value sequentially inputting the plurality of candidate download amounts into the optimization function, and determining a target download amount based on the plurality of target values.

The optimization function constructed, based on the set optimization algorithm, by the actual cached amount, the set cache threshold and the candidate download amount may be represented as: target=−abs (buffer-B+P)/P, where buffer is the actual cached amount, B is the set cache threshold, and P is the candidate download amount. Each candidate download amount is substituted into the optimization function to obtain a target value (that is, a processing result) corresponding to each candidate download amount, and the candidate download amount corresponding to the maximum target value is determined as the target download amount.

Optionally, after the determination of the target download amount based on the actual cached amount and the set cache threshold, the method may further comprise: obtaining at least one of a network speed and video stuttering information, the video stuttering information indicating an occurrence of stutter or an absence of stutter; adjusting the target download amount based on the at least one of the network speed and the video stuttering information.

The network speed may be understood as the speed at which the video data is downloaded, and the video stuttering information may indicate an occurrence of stutter or an absence of stutter.

Optionally, the network speed may be obtained by determining a network speed according to a download amount of a previous video data and a request duration for requesting the previous video data.

The download amount of the last video data may be understood as the data amount of the last video data requested from the server, and the request duration may be understood as a duration for the request, that is, the time required for the video data to be completely downloaded to the client. The manner of determining a network speed according to a download amount of a previous video data and a request duration for requesting the previous video data may be: obtaining the network speed by dividing the data amount of the last video data requested from the server by the request duration of the previous video data.

The method for adjusting the target download amount based on the at least one of the network speed and the video stuttering information may be: in a case where the network speed is less than a first threshold, increasing the target download amount; in a case where the network speed is greater than a second threshold, decreasing the target download amount, wherein the first threshold is less than the second threshold.

The first threshold is less than the second threshold. Increasing the target download amount can be understood as increasing the target download amount by a set value. For example, if the target download amount is 4 seconds, increase the target download amount by 1 second to 5 seconds. Reducing the target download amount can be understood as reducing the target download amount by a set value. For example, if the target download amount is 4 seconds, reduce the target download amount by 1 second to 3 seconds.

In some embodiments, if the network speed is less than the first threshold, it indicates that the network speed is low, and the target download amount is adjusted to ensure the playback quality. If the network speed is greater than the second threshold, it indicates that the network speed is high, and the target download amount is decreased to reduce data download, thereby reducing the transmission cost.

In some embodiments, the manner of obtaining the video stuttering information may be: obtaining video stuttering information in a playback process of a current video; or obtaining video stuttering information within a historical time period.

The historical period can be within 10-15 minutes from the current time. If the user is in the scene of watching a short video, it can be determined whether the user gets stutter while watching the current short video. If the user is watching long videos (such as movies, documentaries, TV dramas, etc.), it is determined whether the user is stutter when watching videos in the historical period.

The target download amount may be adjusted based on the at least one of the network speed and the video stuttering information by increasing the target download amount in a case of an occurrence of stutter.

To avoid an occurrence of the stutter again, the target download amount may be increased to guarantee the playback quality.

S130: Request, from the server, video data of the target download amount for caching.

For example, after determining the target download amount, the client requests the server to cache the video data of the target download amount, which can not only reduce the stutter, but also ensure the stability of the cache amount.

According to the technical solution of the embodiments of the disclosure, the actual cached amount of the video data and the set cache threshold value are obtained in the video playback process; the target download amount is determined based on the actual cache amount and the set cache threshold value; and the video data of the target download amount is requested from the server for caching. According to the method of video caching provided by the embodiments of the disclosure, video data of the determined target download amount is requested from the server for caching, so that a control of the download amount of data can be achieved, and therefore the data waste rate can be reduced and the transmission cost can be saved.

FIG. 2 is a schematic structural diagram of an apparatus of video cache according to embodiments of the present disclosure. As shown in FIG. 2, the apparatus comprises: an obtaining module 210, configured to obtain an actual cached amount of data video and a set cache threshold in a video playback process; a target download amount determination module 220, configured to determine a target download amount based on the actual cached amount and the set cache threshold; a caching module 230, configured to request, from the server, the video data of the target download amount for caching.

Optionally, the target download load determination module 220 is configured to: in accordance with a determination that the actual cached amount is greater than or equal to the set cache threshold, determining the target download amount as a set value; in accordance with a determination that the actual cached amount is less than the set cache threshold, obtaining a target download amount by processing the actual cached amount and the set cache threshold by using a set optimization algorithm.

Optionally, the target download amount determining module 220 is configured to obtain the target download amount by processing the actual cached amount and the set cache threshold by using the set optimization algorithm by: obtaining a plurality of candidate download amounts; obtaining a processing result corresponding to each candidate download amount by processing the actual cached amount, the set cache threshold and each candidate download amount by using the set optimization algorithm; determining a candidate download amount corresponding to a maximum processing result, among processing results corresponding to all candidate download amounts, as a target download amount.

Optionally, the apparatus may be further a target download amount adjustment module, configured to:
obtain at least one of a network speed and video stuttering information, the video stuttering information indicating an occurrence of stutter or an absence of stutter; adjust the target download amount based on the at least one of the network speed and the video stuttering information.

Optionally, the target download load adjustment module is configured to obtain the network speed by determining a network speed according to a download amount of a previous video data and a request duration for requesting the previous video data.

The target download load adjustment module is configured to adjust the target download amount based on the at least one of the network speed and the video stuttering information by in accordance with a determination that the network speed is less than a first threshold, increasing the target download amount; in accordance with a determination that the network speed is greater than a second threshold, decreasing the target download amount, wherein the first threshold is less than the second threshold.

Optionally, the target download amount adjustment module is configured to obtain video stuttering information in a playback process of a current video; or obtain video stuttering information within a historical time period.

Optionally, the target download load adjustment module is configured to adjust the target download amount based on the at least one of the network speed and the video stuttering information by in accordance with a determination of an occurrence of stutter, increasing the target download amount.

The apparatus of video caching provided by the embodiments of the present disclosure may perform the method of video caching provided by any embodiment of the present disclosure and has functional modules and effects for executing the method.

It should be noted that, a plurality of units and modules included in the foregoing apparatus are only divided according to function logic, but are not limited to the foregoing division, as long as a corresponding function can be implemented; in addition, a specific name of each functional unit is merely for ease of distinguishing, and is not intended to limit the protection scope of the embodiments of the present disclosure.

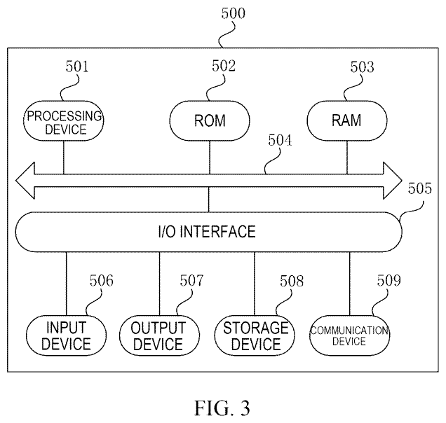

FIG. 3 is a schematic structural diagram of an electronic device according to embodiments of the present disclosure. The reference now is made to FIG. 3, which is a schematic structural diagram of an electronic device (such as the terminal device or server in FIG. 3) suitable for implementing the embodiments of the present disclosure. The terminal device in the embodiments of the present disclosure may include, but is not limited to, a mobile terminal such as a mobile phone, a notebook computer, a digital broadcast receiver, a personal digital assistant (PDA), a tablet computer (PAD), a portable multimedia player (PMP), an in-vehicle terminal (for example, an in-vehicle navigation terminal), and a fixed terminal such as a digital television (TV), a desktop computer, or the like. The electronic device shown in FIG. 3 is merely an example, and should not impose any limitation on the functions and scope of use of the embodiments of the present disclosure.

As shown in FIG. 3, the electronic device 500 may include a processing device (for example, a central processing unit, a graphics processor, etc.) 501, and the electronic device 500 may perform various appropriate actions and processing according to a program stored in a read-only memory (ROM) 502 or a program loaded into a random access memory (RAM) 503 from a storage device 508. In the RAM 503, various programs and data required by the operation of the electronic device 500 are also stored. The processing device 501, the ROM 502, and the RAM 503 are connected to each other through a bus 504. An input/output (I/O) interface 505 is also connected to the bus 504.

Generally, the following devices may be connected to the I/O interface 505: an input device 506 including, for example, a touch screen, a touch pad, a keyboard, a mouse, a camera, a microphone, an accelerometer, a gyroscope, etc.; an output device 507 including, for example, a liquid crystal display (LCD), a speaker, a vibrator, etc.; a storage device 508 including, for example, a magnetic tape, a hard disk, etc.; and a communication device 509. The communication device 509 may allow the electronic device 500 to communicate wirelessly or wired with other devices to exchange data. Although FIG. 3 illustrates an electronic device 500 having a variety of devices, it is to be understood that all illustrated devices are not required to be implemented or provided. More or fewer devices may alternatively be implemented or provided.

According to embodiments of the present disclosure, the process described above with reference to the flowchart may be implemented as a computer software program. For example, embodiments of the present disclosure include a computer program product comprising a computer program embodied on a non-transitory computer readable medium, the computer program comprising program code for performing the method shown in the flowchart. In such embodiments, the computer program may be downloaded and installed from the network through the communication device 509, or installed from the storage device 508, or from the ROM 502. When the computer program is executed by the processing apparatus 501, the foregoing functions defined in the method of the embodiments of the present disclosure are performed.

The names of messages or information interaction between multiple devices in embodiments of the present disclosure are for illustrative purposes only and are not intended to limit the scope of such messages or information.

The electronic device provided by the embodiments of the present disclosure and the method of video caching provided in the foregoing embodiments belong to the same inventive concept, technical details not described in detail in this embodiment may refer to the foregoing embodiments, and this embodiment has the same effect as the foregoing embodiment.

Embodiments of the present disclosure provides a computer storage medium, where a computer program is stored on a computer storage medium, and when the program is executed by a processor, the method of video caching provided in the foregoing embodiments is implemented.

The computer readable medium described above may be a computer readable signal medium or a computer readable storage medium or any combination of the two. The computer-readable storage medium may be, for example, but not limited to, an electrical, magnetic, optical, electromagnetic, infrared, or semiconductor system, device, or device, or any combination thereof. The computer-readable storage medium may include, but is not limited to, an electrical connection having one or more wires, a portable computer diskette, a hard disk, a RAM, a ROM, an electrically erasable programmable read-only memory (EPROM) or a flash memory, an optical fiber, a portable compact disk read-only memory (CD-ROM), an optical storage device, a magnetic storage device, or any suitable combination thereof. In the present disclosure, a computer-readable storage medium may be any tangible medium containing or storing a program that may be used by or in connection with an instruction execution system, apparatus, or device. In the present disclosure, a computer readable signal medium may include a data signal propagated in a baseband or as part of a carrier, and the computer readable signal medium carries a computer readable program code. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted by any suitable medium, including but not limited to: wires, optical cables, Radio Frequency (RF), and the like, or any suitable combination thereof.

In some implementations, the client, server may communicate using any currently known or future developed network protocol, such as Hypertext Transfer Protocol (HTTP), and may be interconnected with any form or medium of digital data communication (e.g., a communication network). Examples of communication networks include Local Area Networks (LANs), Wide Area Networks (WANs), Internet networks (e.g., the Internet), and peer-to-peer networks (e.g., ad hoc peer-to-peer networks), as well as any currently known or future developed networks.

The computer-readable medium described above may be included in the electronic device, or may exist alone or in the electronic device.

The computer readable medium carries one or more programs, and when the one or more programs are executed by the electronic device, the electronic device is caused to: in a video playback process, obtain an actual cached amount of video data and a set cache threshold; determine a target download amount based on the actual cached amount and the set cache threshold; and request the video data of the target download amount from a server for caching.

Computer program code for performing the operations of the present disclosure may be written in one or more programming languages, including, but not limited to, object oriented programming languages such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a LAN or WAN, or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. For example, the first obtaining unit may be further described as “obtaining at least two units of Internet Protocol addresses”.

The functions described above may be performed, at least in part, by one or more hardware logic components. For example, without limitation, the exemplary types of hardware logic components that may be used include: a field programmable gate array (FPGA), an application specific integrated circuit (ASIC), an application specific standard product (ASSP), a system on chip (SOC), a complex programmable logic device (CPLD), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. The machine-readable storage medium may include an electrical connection based on one or more lines, a portable computer disk, a hard disk, a RAM, a ROM, an EPROM or flash memory, an optical fiber, a CD-ROM, an optical storage device, a magnetic storage device, or any suitable combination of the foregoing.

According to one or more embodiments of the present disclosure, there is provided a method of video caching comprising: obtaining an actual cached amount of video data and a set cache threshold in a video playback process; determining a target download amount based on the actual cached amount and the set cache threshold; requesting, from the server, video data of the target download amount for caching.

Optionally, the determining the target download amount based on the actual cached amount and the set cache threshold comprises in accordance with a determination that the actual cached amount is greater than or equal to the set cache threshold, determining the target download amount as a set value; in accordance with a determination that the actual cached amount is less than the set cache threshold, obtaining a target download amount by processing the actual cached amount and the set cache threshold by using a set optimization algorithm.

Optionally, the obtaining the target download amount by processing the actual cached amount and the set cache threshold by using the set optimization algorithm comprises: obtaining a plurality of candidate download amounts; obtaining a processing result corresponding to each candidate download amount by processing the actual cached amount, the set cache threshold and each candidate download amount by using the set optimization algorithm; determining a candidate download amount corresponding to a maximum processing result, among processing results corresponding to all candidate download amounts, as a target download amount.

Optionally, after the determination of the target download amount based on the actual cached amount and the set cache threshold, further comprising: obtaining at least one of a network speed and video stuttering information, the video stuttering information indicating an occurrence of stutter or an absence of stutter; adjusting the target download amount based on the at least one of the network speed and the video stuttering information.

Optionally, obtaining the network speed comprises: determining a network speed according to a download amount of a previous video data and a request duration for requesting the previous video data.

The adjusting the target download amount based on the at least one of the network speed and the video stuttering information comprises: in accordance with a determination that the network speed is less than a first threshold, increasing the target download amount; in accordance with a determination that the network speed is greater than a second threshold, decreasing the target download amount, wherein the first threshold is less than the second threshold.

In some embodiments, the obtaining the video stuttering information comprises: obtaining video stuttering information in a playback process of a current video; or obtaining video stuttering information within a historical time period.

Optionally, the adjusting the target download amount based on the at least one of the network speed and the video stuttering information comprising: in accordance with a determination of an occurrence of stutter, increasing the target download amount.

1-10. (canceled)

11. A method of video caching, comprising:
obtaining an actual cached amount of video data and a set cache threshold in a video playback process;
determining a target download amount based on the actual cached amount and the set cache threshold;
requesting, from the server, video data of the target download amount for caching.

12. The method of claim 11, wherein the determining the target download amount based on the actual cached amount and the set cache threshold comprises:
in accordance with a determination that the actual cached amount is greater than or equal to the set cache threshold, determining the target download amount as a set value;
in accordance with a determination that the actual cached amount is less than the set cache threshold, obtaining a target download amount by processing the actual cached amount and the set cache threshold by using a set optimization algorithm.

13. The method of claim 12, wherein the obtaining the target download amount by processing the actual cached amount and the set cache threshold by using the set optimization algorithm comprises:
obtaining a plurality of candidate download amounts;
obtaining a processing result corresponding to each candidate download amount by processing the actual cached amount, the set cache threshold and each candidate download amount by using the set optimization algorithm;
determining a candidate download amount corresponding to a maximum processing result, among processing results corresponding to all candidate download amounts, as a target download amount.

14. The method of claim 11, after the determination of the target download amount based on the actual cached amount and the set cache threshold, further comprising:
obtaining at least one of a network speed and video stuttering information, the video stuttering information indicating an occurrence of stutter or an absence of stutter;
adjusting the target download amount based on the at least one of the network speed and the video stuttering information.

15. The method of claim 14, wherein obtaining the network speed comprises:
determining a network speed according to a download amount of a previous video data and a request duration for requesting the previous video data;
the adjusting the target download amount based on the at least one of the network speed and the video stuttering information comprises:
in accordance with a determination that the network speed is less than a first threshold, increasing the target download amount;
in accordance with a determination that the network speed is greater than a second threshold, decreasing the target download amount, wherein the first threshold is less than the second threshold.

16. The method of claim 14, wherein obtaining the video stuttering information comprises:
obtaining video stuttering information in a playback process of a current video; or
obtaining video stuttering information within a historical time period.

17. The method of claim 16, wherein the adjusting the target download amount based on the at least one of the network speed and the video stuttering information comprising:
in accordance with a determination of an occurrence of stutter, increasing the target download amount.

18. An electronic device, comprising:
at least one processor;
a storage device, configured to store at least one program;
when the at least one program is executed by the at least one processor, the at least one processor implements a method comprising:
obtaining an actual cached amount of video data and a set cache threshold in a video playback process;
determining a target download amount based on the actual cached amount and the set cache threshold;
requesting, from the server, video data of the target download amount for caching.

19. The device of claim 18, wherein the determining the target download amount based on the actual cached amount and the set cache threshold comprises:
in accordance with a determination that the actual cached amount is greater than or equal to the set cache threshold, determining the target download amount as a set value;
in accordance with a determination that the actual cached amount is less than the set cache threshold, obtaining a target download amount by processing the actual cached amount and the set cache threshold by using a set optimization algorithm.

20. The device of claim 19, wherein the obtaining the target download amount by processing the actual cached amount and the set cache threshold by using the set optimization algorithm comprises:
obtaining a plurality of candidate download amounts;
obtaining a processing result corresponding to each candidate download amount by processing the actual cached amount, the set cache threshold and each candidate download amount by using the set optimization algorithm;
determining a candidate download amount corresponding to a maximum processing result, among processing results corresponding to all candidate download amounts, as a target download amount.

21. The device of claim 18, after the determination of the target download amount based on the actual cached amount and the set cache threshold, further comprising:
obtaining at least one of a network speed and video stuttering information, the video stuttering information indicating an occurrence of stutter or an absence of stutter;
adjusting the target download amount based on the at least one of the network speed and the video stuttering information.

22. The device of claim 21, wherein obtaining the network speed comprises:
determining a network speed according to a download amount of a previous video data and a request duration for requesting the previous video data;
the adjusting the target download amount based on the at least one of the network speed and the video stuttering information comprises:
in accordance with a determination that the network speed is less than a first threshold, increasing the target download amount;
in accordance with a determination that the network speed is greater than a second threshold, decreasing the target download amount, wherein the first threshold is less than the second threshold.

23. The device of claim 21, wherein obtaining the video stuttering information comprises:
obtaining video stuttering information in a playback process of a current video; or obtaining video stuttering information within a historical time period.

24. The device of claim 23, wherein the adjusting the target download amount based on the at least one of the network speed and the video stuttering information comprising:
in accordance with a determination of an occurrence of stutter, increasing the target download amount.

25. A non-transitory storage medium comprising computer executable instructions, the computer executable instructions executed by a computer processor are configured to perform method comprising:
obtaining an actual cached amount of video data and a set cache threshold in a video playback process;
determining a target download amount based on the actual cached amount and the set cache threshold;
requesting, from the server, video data of the target download amount for caching.
